(19) United States
(12) Patent Application Publication
(10) Pub. No.: US 2025/0338109 A1
(43) Pub. Date: Oct. 30, 2025

(54) SYSTEM AND METHOD TO RESTORE ESIM PROFILE ON SM-DP+ PLATFORM

(71) Applicant: Rakuten Symphony, Inc., Tokyo (JP)

(72) Inventor: Ashutosh GUPTA, Andaman and Nicobar Islands (IN)

(21) Appl. No.: 18/651,639

(22) Filed: Apr. 30, 2024

(51) Int. Cl. H04W 8/18

(52) U.S. Cl. CPC H04W 8/183

(57) ABSTRACT

A device profile provisioning system is provided. A Subscription Management Data Preparation (SM-DP+) server receives a request to download a profile package to an embedded Universal Integrated Circuit Card (eUICC) of a user equipment (UE). The SM-DP+ server sends the profile package to the eUICC. The SM-DP+ server determines whether the profile package is in an error state. The SM-DP+ resets the profile package to be in a released state to download in response to the SM-DP+ determining the error state. The SM-DP+ sends a notification to an end user informing the end user the profile package is available to download.

### FIELD

The present disclosure relates to a system and method to restore eSIM profile on SM-DP+ platform.

### BACKGROUND

Mobile devices, such as smart phones, tablets, are configured to utilize Universal Integrated Circuit Cards (UICCs) that enable the mobile devices to access wireless services provided by telecom operators/service providers, referred to as user equipment (UE), or a portable device. The UICC identifies a UE on a particular mobile network. Once a UE is registered with the mobile network using a Subscriber Identity Module (SIM), the UE utilizes the mobile communication service from the mobile network of the registration destination. However, a UICC-enabled SIM limits the user/subscriber to a single default profile, which is placed on the SIM card embedded within the UE at the time of manufacture of the UE. The profile associated with the SIM card, however, is static. If the subscriber wants to remotely activate the profile embedded with the SIM card of the UE and some type of error is generated, then the subscriber replaces the SIM card within the UE.

With the development of Embedded Universal Integrated Circuit Cards (eUICCs), subscribers have the ability to change from one service provider to another service provider over-the-air (OTA), without physically changing the embedded SIM card itself. This ability is referred to as remote SIM provisioning, which allows a subscriber to remotely activate the SIM embedded in a portable device, such as a smart phone, smart watch, fitness band, tablet computer, or similar device.

Remote SIM Provisioning enables control over remote provisioning and local management of operator profiles by the end user of the UE. Remote SIM Provisioning is organized around an architecture, referred to as the Subscription Manager-Data Preparation+ (SM-DP+), wherein the “+” indicates the integration of the SM-DP and the Subscription Management Secure Routing (SM-SR), which is a machine-to-machine (M2M) architecture. The SM-DP+ is responsible for the creation, download, remote management (i.e., enable, disable, update, delete), and the protection of operator credentials (the profiles), and the SM-DP+ performs at least the functions of a server and a database, and server and database are interchangeably used herein.

### SUMMARY

In at least one embodiment, a method of provisioning a device profile, including receiving, by a Subscription Management Data Preparation (SM-DP+) server, a request to download a profile package to an embedded Universal Integrated Circuit Card (eUICC) of a user equipment (UE). In at least one embodiment, a method of provisioning a device profile, including sending, by the SM-DP+ server, the profile package to the eUICC. In at least one embodiment, a method of provisioning a device profile, including determining, by the SM-DP+ server, whether the profile package is in an error state. In at least one embodiment, a method of provisioning a device profile, including resetting, by the SM-DP+, the profile package to be in a released state to download in response to the SM-DP+ determining the error state. In at least one embodiment, a method of provisioning a device profile, including sending a notification to an end user informing the end user the profile package is available to download.

In at least one embodiment, a Subscription Management Data Preparation (SM-DP+) server for provisioning a profile, wherein the SM-DP+ server is configured to receive a request to download a profile package to an embedded Universal Integrated Circuit Card (eUICC) of a user equipment (UE); send the profile package to the eUICC. The SM-DP+ server is further configured to determine whether the profile package is in an error state. The SM-DP+ server is further configured to reset the profile package to be in a released state to download in response to the SM-DP+ determining the error state. The SM-DP+ server is further configured to send a notification to an end user informing the end user the profile package is available to download.

In at least one embodiment, a non-transitory computer-readable media having computer-readable instructions stored thereon, which in response to being executed causes a Subscription Management Data Preparation (SM-DP+) server to perform operations including receiving, by the SM-DP+ server, a request to download a profile package to an embedded Universal Integrated Circuit Card (eUICC) of a user equipment (UE). The instructions further cause the SM-DP+ server to perform operations including sending, by the SM-DP+ server, the profile package to the eUICC. The instructions further cause the SM-DP+ server to perform operations including determining, by the SM-DP+ server, whether the profile package is in an error state. The instructions further cause the SM-DP+ server reset, by the SM-DP+, the profile package to be in a released state to download in response to the SM-DP+ determining the error state. The instructions further cause the SM-DP+ server to perform operations including sending a notification to an end user informing the end user the profile package is available to download.

### BRIEF DESCRIPTION OF THE DRAWINGS

Features, aspects, and advantages of certain exemplary embodiments of the disclosure will be described below with reference to the accompanying drawings, in which like reference numerals denote like elements, and wherein:

FIG. 1 is a diagram of example components of a system for providing eSIM profile provision at Subscription Management Data Preparation (SM-DP+) server, in accordance with some embodiments.

FIG. 2 is a diagram of an example flowchart for SIM profile generation and download on SM-DP+, in accordance with some embodiments.

FIG. 3 is a diagram of an example flowchart for remote SIM provisioning architecture, in accordance with some embodiments.

FIG. 4 is a diagram of example lifecycle states of a SIM profile, in accordance with some embodiments.

FIG. 5 is a diagram of an example pipeline of the function of each entity related to checking a state of a SIM profile, in accordance with some embodiments.

FIG. 6 is an example of a high-level functional block diagram of a processor-based system, in accordance with some embodiments.

FIG. 7 is a diagram of a system for restoring an ESIM profile, in accordance with some embodiments.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched, as long as these modifications may not affect the resulting scope of the invention.

It will be apparent that systems and/or methods, described herein, may be implemented in different forms of hardware, software, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]”, “[A] and/or [B]”, or “at least one of [A] or [B]” are to be understood as including only A, only B, or both A and B. The foregoing disclosure provides illustration and description but is not intended to be exhaustive or to limit the implementations to the precise form disclosed. Modifications and variations are possible in light of the above disclosure or may be acquired from practice of the implementations.

To create or generate a 4G and 5G profile for a subscriber, the SM-DP+ creates/generates the 4G and 5G profiles for the portable device. However, telecom operators/service providers, which provide the subscriber information details, have found management to be difficult for multiple profiles associated with a subscriber, i.e., a separate 4G profile and a separate 5G profile. For example, porting of a eUICC Profile 4G to 5G or inversely 5G to 4G supported handset is complex. While in the aforementioned case where multiple profiles are created for 4G and 5G, multiple profiles are also able to be created in response to improper installation of a profile on the SIM. Improper installation is able to occur due to a variety of errors discussed herein, and a profile associated with an error state is not able to be changed to a released state, and is no longer available to download on to the SIM. Regardless, duplication of profiles occurs on the SM-DP+ database. On the SM-DP+ database, at least two profile records are created in the profile inventory for the same subscriber. One of the profiles is able to be enabled by the subscriber but not both, so another profile is not useful to the subscriber nor to the telecom operator/service provider. Due to duplication of profiles, memory in the SM-DP+ database is wasted, which comes as a cost to a telecom operator/service provider. Another cost comes in the form of an inconvenience and waste of time to the subscriber who may not be able to access a network as a result, and have to consult with a technician of the telecom operator/service provider to remedy the error.

To help address the problems associated with SM-DP+, a state of a profile is able to be changed from an error state to a released state. This is able to be achieved by the ES2+ function, DownloadOrderReset ( ) which has been developed to support SM-DP+. Said function has the ability to change the profile from an error to a released state. Once the state of the profile is moved to the released state, the subscriber is able to redownload the profile via SM-DP+.

The aforementioned function instructs the SM-DP+ to change the profile state from an error state to a released state based on a profile's download control attributes, the attributed including reset download order attempts (resetDownloadAttempts), renew confirmation code (confirmationCode), and renew order expiration time (orderExpirationTime). The download control attributes are able to be inputted into the SM-DP+ to identify a profile of interest so as to download and install the profile in the EUICC. In response to the function being received by the SM-DP+, the state of the profile undergoes a check. In some embodiments, if the check indicates the profile is not in an error state, then the profile remains available to the telecom operator/service provider. In some embodiments, if the check indicates the profile is in an error state, then the SM-DP+ searches a profile inventory of the SM-DP+ database for an integrated circuit card identification (ICCID). In some embodiments, a search indicates a profile is booked by an eUICC (also referred to as an EID identifier) and a subscription management discovery service (SM-DS) address. Whether the profile is booked is determined by the ES2+ Interface function, ES2+.ConfirmOrder. The ES2+ interface is utilized by telecom operator/service provider to order profiles for particular eUICCs and other administrative functions. If the profile is booked according to the ES2+.ConfirmOrder function then this is indicative of a registration event in the SM-DS, and a profile is able to be downloaded in an eSIM supported device without the device having to scan a QR code.

If a profile is changed to an error state due to an error case, such as exceeding the confirmation code retry limit, exceeding the download retry limit, subscriber/end user rejection, or other error during download and installation or eligibility check fails, or order expiration, the SM-DP+ deletes the registration event from the SM-DS. After deletion of the registration event, the ES12.RegisterEvent (EID) function instructs the SM-DP+ to again perform a registration event which releases the profile from an error state so that a subscriber is able to download the profile again from the SM-DP+. After registration event request is successfully valid a server of the SM-DP+ restores the profile from its error state to a released state. The SM-DP+ then updates the resetDownloadAttempts, resetConfirmationCodeAttempts, and orderExpirationTime to a maximum value, and if a new date is inputted in the orderExpirationTime field then SM-DP+ will update new expiration date of that profile.

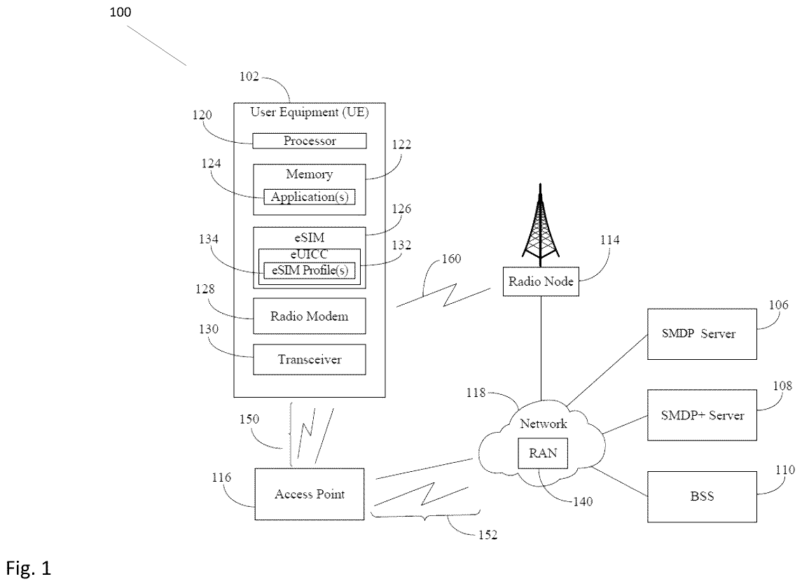

FIG. 1 is a diagram 100 of a system for providing eSIM profile provision at Subscription Management Data Preparation (SM-DP+) server, in accordance with some embodiments.

In FIG. 1, system 100 includes UE 102, a SM-DP+ Server 108, a Business Support Systems (BSS) 110, a Radio Node 114, an Access Point 116, and a Network 118. UE 102 includes Processor 120 and Memory 122. Memory 122 includes non-transitory memory portion that stores Application 124. UE 102 also includes an eSIM 126, a Radio Modem 128, and a Transceiver 130 (e.g., a Wi-Fi Transceiver). The eSIM 126 includes an Embedded Universal Integrated Circuit Card (eUICC) 132. In different embodiments, the UE 102 is a mobile phone, a media player, a laptop computer, a tablet computer, a notebook computer, an IoT device, a smart watch, a fitness band, smart glasses (or other wearable computer), or any other device providing communication and processing services.

The Radio Modem 128 includes a mobile radio transceiver and a processor. Alternatively, the mobile radio transceiver is a separate component from Radio Modem 128. UE 102 establishes a wireless communication link with Radio Node 114, such as an Evolved Node B (eNodeB or eNB), Next Generation e-NodeB (ng-eNB), Next Generation Node B d (gNB), or other type of wireless base station. Radio Node 114 provides access to Network 118 using any of a variety of wireless communication protocols.

UE 102 is also able to be configured to use Transceiver 130 to establish a communication link with, for example, Access Point 116 to provide access to Network 118. Network 118 is one or more private networks, one or more public networks, or a combination thereof. For example, Network 114 includes Radio Access Network (RAN) 140 of a telecommunications service provider.

RAN 120 is responsible for managing radio resources, including strategies and algorithms for controlling power, channel allocation and data rate. RANs 120 have evolved over time, from 3G to 5G. For example, RANs 120 are implemented in various configurations, such as Global System for Mobile Communications (GSM) RAN (GRAN), GSM Enhanced Data Rates for GSM Evolution (EDGE) RAN (GERAN), Universal Mobile Telecommunications Service (UMTS) Terrestrial RAN (UTRAN), Evolved UMTS Terrestrial RAN (E-UTRAN), Centralized/Cloud RAN (CRAN), Virtualized RAN (VRAN), and Open RAN (ORAN). UE 102 accesses Network 118 for communication services.

Connections 150, 152 are implemented using at least one of a wireless connection or a wired connection. In at least one embodiment, Connections 150, 152 are implemented as a wireless connection in accordance with any IEEE 802.11 Wi-Fi protocols, Bluetooth protocols, Bluetooth Low Energy (BLE), or other short range protocols that operate in accordance with a wireless technology protocol for exchanging data using any licensed or unlicensed band such as the citizens broadband radio service (CBRS) band, 2.4 GHz bands, 5 GHz bands, or 6 GHz bands. Additionally, in at least one embodiment, Connections 150, 152 are implemented using a wireless connection that operates in accordance with, but is not limited to, RF4CE protocol, ZigBee protocol, Z-Wave protocol, or IEEE 802.15.4 protocol. In at least one embodiment, Connections 150, 152 are implemented using a coax (MoCA) network. In at least one embodiment, Connections 150, 152 are a wired Ethernet connection. Connection 160 is implemented as a 4G or 5G connection, depending on Radio Modem 128 and Radio Node 114.

BSS 110 is the software and processes used for the “back office” to function. The scope of BSS 110 includes managing rating, orders, products, billing, fraud, and customer relations. Also included are providing revenue assurance and business intelligence. BSS 110 creates Production Batch Request on the SM-DP+ Server 108 for creation of Profiles. BSS 110 provides an Input file to the SM-DP+ 108 which contains subscriber information (IMSI, ICCID, MSISDN, etc.,). After generation of a Profile, BSS 110 receives the output file for that corresponding Batch. The output file contains the Subscriber Information along with generated OTA keys for the subscribers.

The SM-DP+ 108 is an online resource that makes eSIM Profiles 134 available for download to UE 102. The eSIM Profile 134 is the software that is downloaded to an eSIM-enabled device, e.g., UE 102, to access a mobile network. The SM-DP+ 108 distributes eSIM Profiles 134 used to access network 118. Data carriers will collect IMEI and EID numbers from subscribers and “provision” an eSIM for UE on the SM-DP+ 108. UE 102 contacts the SM-DP+ 108 to download eSIM Profile 134.

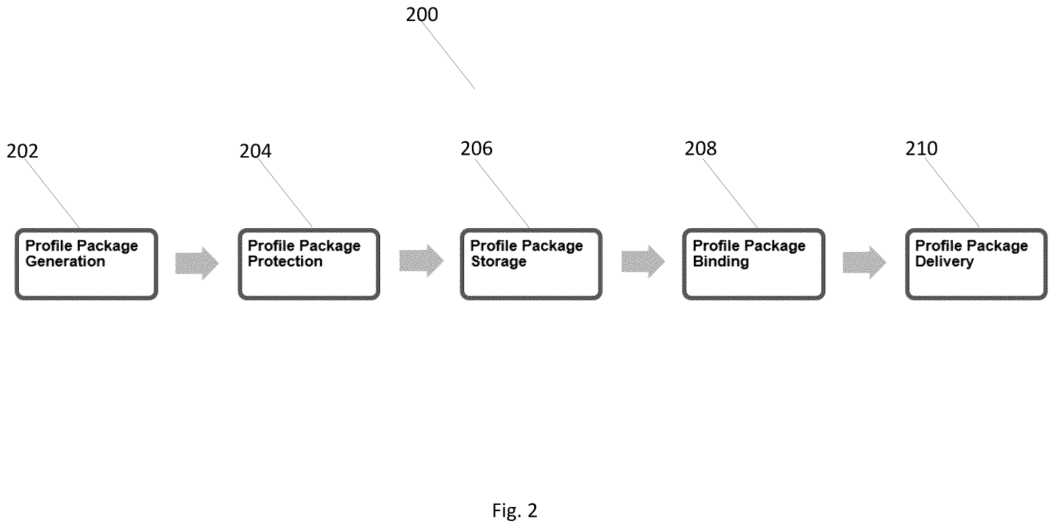

FIG. 2 is a flowchart 200 for eSIM profile generation and download/delivery on the SM-DP+, in accordance with some embodiments.

Profile Package Generation 202 refers to the SM-DP+ generating the eSIM Profile, including IMSI, Ki, ICCID, on the SM-DP+ as per the subscriber information provided by the operator. Profile Package Generation 202 provides that profiles are able to be generated in off-line batches or during a real time process. SM-DP+ certification requires the SM-DP+ elements to use, per CERTDP3, Hardware Security Modules (HSM) for cryptographic related operations (key storage, derivation, cryptographic operations). SM-DP+ certification requires the SM-DP+ elements to implement, via CERTDP4, privileges isolation, e.g., Log, Audit (of event registrations), Operation, and Administration.

Profile Package Protection 204 refers to the eSIM profile containing Class A sensitive information so the information will be encrypted by a Profile Protection Key (PPK) and converted into a Protected Profile Package (PPP). Profile Package Protection 204 provides safe data wipe for stored and in-memory operations on plain-text profiles; HSM services for package protection; importing of non-sensitive information to aid indexing.

Profile Package Storing 206 refers to temporarily storing of the Protected Profile Package (PPP) in the SM-DP+ along with Profile Protection key for subsequent delivery to the eUICC. Profile Package Storing 206 provides indexing profile metadata; securely transferring and storing on a delivery site; and establishing control of profile state.

Profile Package Binding 208 refers, to after profiles are stored in the SM-DP+ database, the profiles are booked/ordered via the ES2+ interface and downloaded by the ES9+ interface. The profile is bound with eUICC information at the request of an operator per SMDP4, i.e., EID and eUICC identification information, and converted into a Bound Profile Package. Profile Package Binding 208 provides compliant ES2+ interface; secure interface to operators and partners after completing all production steps, Profile Package Protection 204, and binding; routing among delivery sites; and pre-encryption bound to target eUICC.

Profile Package Delivery 210 refers to during the downloading of the profile from the SM-DP+ up to delivery of the profile to the eSIM Device via the ES9+ interface. Profile Package Delivery 210 provides compliant ES9+ interface; mutual authentication with eUICC using HSMs; main target for performance and availability.

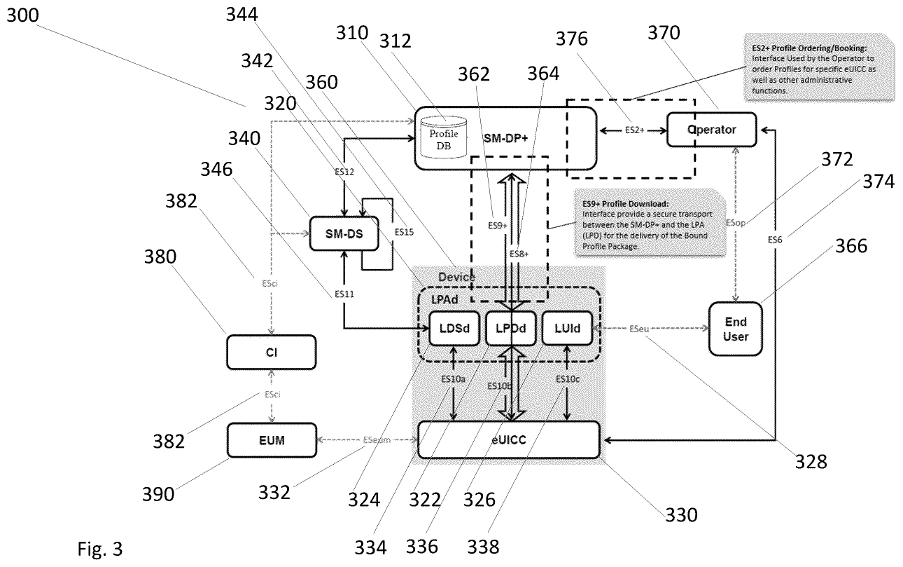

FIG. 3 is a flowchart 300 for remote SIM provisioning architecture, in accordance with some embodiments.

In FIG. 3, the SIM provisioning architecture 300 includes SMDP+ 310, Local Profile Assistant (LPA) 320, embedded Universal Integrated Circuit Card (eUICC) 330, and Subscription Manager-Discovery Server (SM-DS) 340.

SM-DP+ 310 is responsible for the creation, download, remote management (enable, disable, update, delete) and the protection of operator credentials (the Profile). A Local Profile Assistant (LPA) 320 provides the capability to download encrypted Profiles to the eUICC. The LPA 320 also presents the local management end user interface to the end user so the users are able to manage the status of Profiles on the eUICC 330. The LPA 320 is able to be built into the eUICC 330. The eUICC 330 is a secure element that contains one or more subscription Profiles. A Profile enables the eUICC to function in the same way as a removable SIM issued by the operator 370. SM-DS 340 provides a means for the SM-DP+ 310 to reach the eUICC 330 without knowing which network the UE is connected to. Accordingly, UEs are able to be connected using different access networks with different addresses. The SM-DS 340 overcomes this by allowing the SM-DP+ 310 to post alerts to a secure noticeboard and for UEs to extract those alerts and is used to notify the LPA 320 when Profile data is available for download to the eUICC 330. Notifications are sent from the SMDP+ 310 to the SM-DS 340. The LPA 320 polls the SM-DS 340 for notifications when used (supporting the “pull” model). Polling frequency is determined by the state of the eUICC 330 and by end user actions.

An eSIM or profile includes software and authentication functions related to a mobile network operator (MNO) 370. The profile is present on a secure element (SE) within a wireless device receiving services from the MNO 370. Universal integrated circuit cards (UICCs) and embedded UICCs (eUICCs) are examples of SEs used for hosting profiles. A new profile is provisioned by the SM-DP+ Server 410 to eUICC 330 of Device 360.

A profile is a combination of operator data and applications provisioned on an SE in a device for the purpose of providing services by an operator, for example, an MNO 370. An SE is identified by an eUICC identifier, which is a unique number that is referred to as an EID. A profile is identified by a unique number, an Integrated Circuit Card Identifier (ICCID).

An enabled profile includes files and/or applications which are selectable over an interface between an SE of device 360 and processing circuitry of the device external to the SE. To use the device 360, the profile is activated with the MNO 370. Placing a new profile on an SE within device 360 is referred to as provisioning. A logical entity in the device that assists with provisioning is a combination of hardware, firmware, and/or device software, including, for example, a Local Profile Assistant (LPA) 320.

Communications of an eUICC are authenticated using public key infrastructure (PKI) techniques. Certificates used for authentication and confidentiality purposes are generated by a certificate issuer (CI) 380. The SM-DS 440 holds a list of profiles which are available to an end user in eUICC 330. The SM-DS 340 and the eUICC Manufacturer (EUM) 390 use ESci interface 382 to request a Certificate and retrieve Certificate revocation status from a Certificate Issuer (CI) 380. A Certificate issued by CI 380 to EUM 390 is used to verify eUICC Certificates. EUM 390 is the manufacturer of an eUICC 330. The EUM 390 and the eUICC 330 communicate via the ESeum Interface 332.

The SM-DP+ 310 takes the raw profile information from an MNO 370, personalizes the raw profile information with the appropriate IMSI/Ki pair information, converts the personalized information to the appropriate format for an eUICC 330 and causes the profiles to be provided to the eUICC 330.

In response to being located in the device 360, the LPA 320 is referred to as LPAd. The LPA is also able to be in the eUICC, i.e., LPAe. The LPA 320 provides features of a Local Profile Download (LPD) 322, Local Discovery Services (LDS) 324, and a Local User Interface (LUI) 326.

The LPA 320 transmits information stored in the eUICC 330 (e.g., MNO network information, MNO profile information, and the like) to the SM-DP+ 310, or stores information received from the SM-DP+ 310 via the ES9+ interface 362 in the eUICC 330. The ES9+362 interface provides a secure transport for the delivery of the Bound Profile Package between the SM-DP+ 310 and the LPAd 320. ES8+364 provides a secure end-to-end channel between the SM-DP+ 310 and the eUICC 330 for the administration of the profile during download and installation.

The End User 366 communicates with the LUI 326 via the ESeu interface 328. Local Profile Management are operations that are locally initiated on the ESeu interface 328. Local Profile Management Operations include enable Profile, disable Profile, delete Profile, query Profile Metadata, eUICC Memory Reset, eUICC test memory reset, set/edit nickname, add a profile, and edit default SM-DP+ address.

The ES12 interface 342 allows the SM-DP+ 310 to issue or remove event registrations on the SM-DS 340. In the case of deployments with cascaded SM-DSs 340, the ES15 interface 344 is used to connect to the SM-DSs 340. The ES11 interface 346 allows the LDS 324 to retrieve Event Records for the respective eUICC 330.

The ES10a interface 334 is used by the LPAd 320 in the Device 360 to obtain the configured addresses from the eUICC 330 for Root SM-DS 340, and optionally the default SM-DP+ 310. The ES10b interface 336 is used by the LPDd 322 in the Device 360 and the services of LPAd 320 to transfer a Bound Profile Package to the eUICC 330. The ES10c interface 338 is used between the LUId 326 in the Device 360 and the services of LPAd 320 for Local Profile Management by the End User 366.

The MNO 390 communicates with the End User 366 via the ESop interface 372. The ES6 interface 374 is used by the MNO 370 for the management of operator services via OTA services. MNO 370 has access to a SM-DP+ 310 via the ES2+ interface 376. The MNO 370 uses the ES2+ interface 376 to order Profiles for specific eUICCs 330 as well as other administrative functions. As described above, the SM-DP+ 310 maintains a Profile Database 312, e.g., the Profile Inventory.

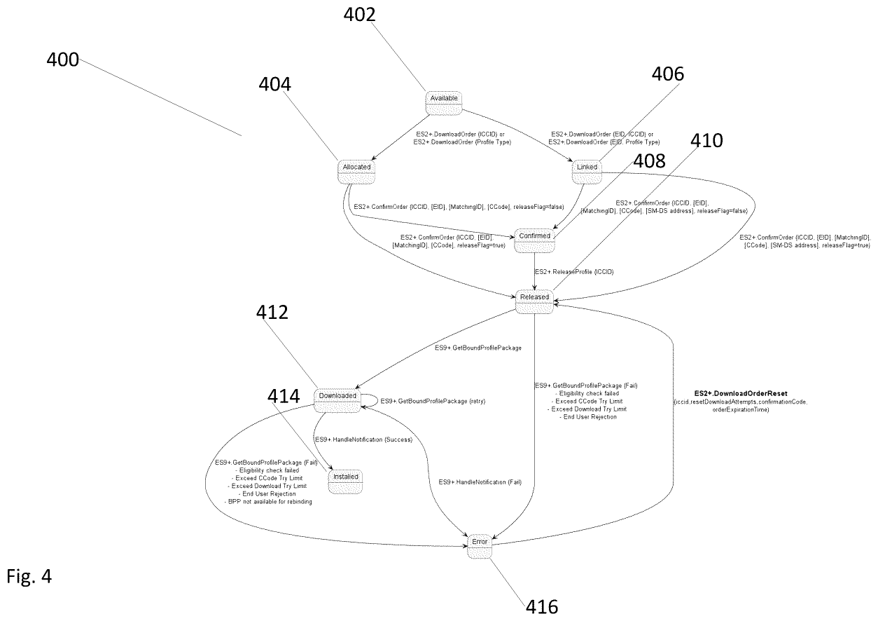

FIG. 4 is a diagram 400 of lifecycle states of a SIM profile, in accordance with some embodiments.

In the Available state 402 refers to a profile in the Profile Database 312 of the SM-DP+ 310 that has not been ordered by the Operator 370 for Device 360. A DownloadOrder function request of a profile is then sent via the ES2+376 between the SM-DP+ 310 and the Operator 370. In some embodiments, the profile obtains an Allocated state 404. In some embodiments, the profile obtains a Linked state 406. In some embodiments, a DownloadOrder function request is for an ICCID. In some embodiments, a DownloadOrder function request is for a Profile Type.

In the Allocated state 404 refers to a profile in the Profile Database 312 of the SM-DP+ 310 that has been ordered by the Operator 370 for Device 360, and is a profile that is reserved for download without being linked to an EID. A ConfirmOrder function request is sent via the ES2+376 between the SM-DP+ 310 and the Operator 370 so as to convert the profile from the Allocated state 404 to the Confirmed state 408. In this embodiment, releaseFlag=False. In some embodiments, a ConfirmOrder function request is sent via the ES2+376 between the SM-DP+ 310 and the Operator 370 so as to convert the profile from the Allocated state 404, bypassing the Confirmed state 408, to the Released state 410. In this embodiment, releaseFlag=True.

In the Linked state 406 refers to a profile in the Profile Database 312 of the SM-DP+ 310 that has been ordered by the Operator 370 for Device 360, and is a profile that is reserved for download and is linked to an EID. A ConfirmOrder function request is sent via the ES2+376 between the SM-DP+ 310 and the Operator 370 so as to convert the profile from the Linked state 406 to the Confirmed state 408. As discussed above, the SM-DS address refers to the SM-DS 340, which provides a means for an SM-DP+ 310 to reach the eUICC without having to know which network the Device 360 is connected to considering that devices are able to be connected using different access networks with different addresses. In this embodiment, releaseFlag=False. In some embodiments, a ConfirmOrder function request is sent via the ES2+376 between the SM-DP+ 310 and the Operator 370 so as to convert the profile from the Linked state 406, bypassing the Confirmed state 408, to the Released state 410. In this embodiment, releaseFlag=True.

In the Confirmed state 408 refers to a profile that is reserved for download, regardless of whether the profile is linked (Linked state 406) or not linked (Allocated state 404) to an EID. In some embodiments, a profile is reserved with a matching ID. In some embodiments, a profile is reserved with a confirmation code. Regardless of whether the profile is linked or not linked to an EID, the order is reserved for download between the SM-DP+ 310 and the Operator 370 via the ES2+376. A ReleaseProfile function request is sent via the ES2+376 between the SM-DP+ 310 and the Operator 370 so as to convert the profile from the Confirmed state 408 to the Released state 410.

In the Released state 410 refers to the profile being ready for download and installation after network configuration by the Operator 370, e.g., Home Location Registration (HLR). In the Released state 410, the profile resides in the Profile Database 312 of the SM-DP+ 310 until the profile is completely downloaded on to the Device 360. In this embodiment, releaseFlag=True. Once a profile has a Released state 410, a Get Bound Profile Package request is sent via the ES9+362 between the SM-DP+ 310 and the LPA 320 of the Device 360 so as to convert the profile from the Released state 410 to the Downloaded state 412.

In the Downloaded state 412 refers to binding of the profile, and the bound profile being delivered by the ES9+362 to the LPA 320 on the Device 360. In some embodiments, a GetBoundProfilePackage function request is sent via the ES9+362 between the SM-DP+ 310 and the LPA 320 of the Device 360 to re-try downloading the profile package. In some embodiments, a HandleNotification function request is sent via the ES9+362 between the SM-DP+ 310 and the LPA 320 of the Device 360 so as to convert the profile from the Downloaded state 412 to the Installed state 414.

In the Installed state 414 refers to the profile being successfully installed on the eUICC 330.

In the Error state 416 refers to the profile not being installed as a result of one of multiple error scenarios discussed above. Once a profile is in the Error state 416, the profile is unavailable, and cannot be re-used by the SM-DP+.

In some embodiments, once a profile has a Released state 410, a GetBoundProfilePackage function request is sent via the ES9+362 between the SM-DP+ 310 and the LPA 320 of the Device 360, but the request fails due to an error scenario as discussed below, so the profile, instead of going from the Released state 410 to the Downloaded state 412 and/or the Installed state 414, goes to the Error State 416.

In some embodiments, once a profile has a Downloaded state 412, a GetBoundProfilePackage function request is sent via the ES9+362 between the SM-DP+ 310 and the LPA 320 of the Device 360, but the request fails due to an error scenario as discussed below, so the profile, instead of going from the Downloaded state 412 to the Installed state 414, goes to the Error State 416. In addition to the error scenarios discussed below, one of the error scenarios is a bound profile package not being available for re-binding.

In some embodiments, an error occurs due to the confirmation code retry limit being exceeded, e.g., end user enters the wrong confirmation code. In some embodiments, an error occurs due to the download retry limit being exceeded, e.g., end user's device is limited to 4G capability and end user unintentionally downloaded a profile configured for a device with 5G capability. In some embodiments, an error occurs due to rejection by the End User 366. In some embodiments, an error occurs during download, e.g., disconnection of internet during downloading, not enough memory on the Device 360 to store profile data, and installation. In some embodiments, an error occurs due to failing an eligibility check, which is similar to the above error scenario-a device being configured for 4G, but a profile is downloaded for 5G. In some embodiments, an error occurs due to order expiration, i.e., not downloading the profile before a certain time.

In some embodiments, a profile in the Error state 416 is able to be converted back into the Released state 410 by a DownloadOrderReset function request that is sent via the ES2+376 between the SM-DP+ 310 and the Operator 370. Once a profile is moved to the Released state 410 a user/subscriber is able to re-download the profile via the SM-DP+ 310. In some embodiments, a user is able to connect to the Operator 370, and the Operator 370 is able to change the profile back to the Released state 410, so that the End User 366 is able to download the profile on to the Device 360. In some embodiments, the SM-DP+ 310 modifies the profile's download control attributes based on request content. In some embodiments, the profile's download control attribute is a reset download order attempt, or a resetDownloadAttempts function request. In some embodiments, the profile's download control attribute is a renew confirmation code to provide a user with a new confirmation code, or a confirmationCode function request. In some embodiments, the profile's download control attribute is a renew order expiration time, or a orderExpirationTime function request.

Once the SM-DP+ 310 receives the DownloadOrderReset #function, and in response to receiving the DownloadOrderReset #if the profile is not in the Error state 416, then the SM-DP+ 310 performs a search of the ICCID in the profile inventory of the Profile Database 312 in the SM-DP+ 310.

In some embodiments, a profile is previously booked by EID and SM-DS 340 address via ES2+376 (via interface function ES2+.ConfirmOrder), which indicates an event is registered in the SM-DS 340 so that a profile is able to be downloaded in the Device 360 (e.g., eSIM supported devices) without a QR Code. If the profile state is changed to an Error state 416 due to one of the aforementioned error scenarios, then the SM-DP+ 310 deletes the Events from the SM-DS 340. The SM-DP+ 310 then again registers the events, so that once the profile is converted back to the Released state 410, the End User 366 is able to download the profile again from the SM-DP+ 310.

After successful validation of request, the SM-DP+ 310 will convert the profile back to the Released state 410, and update the resetDownloadAttempts and theresetConfirmationCodeAttempts to a maximum value. If a new date is provided in the orderExpirationTime field then the SM-DP+ 310 will update a new expiration date of that profile.

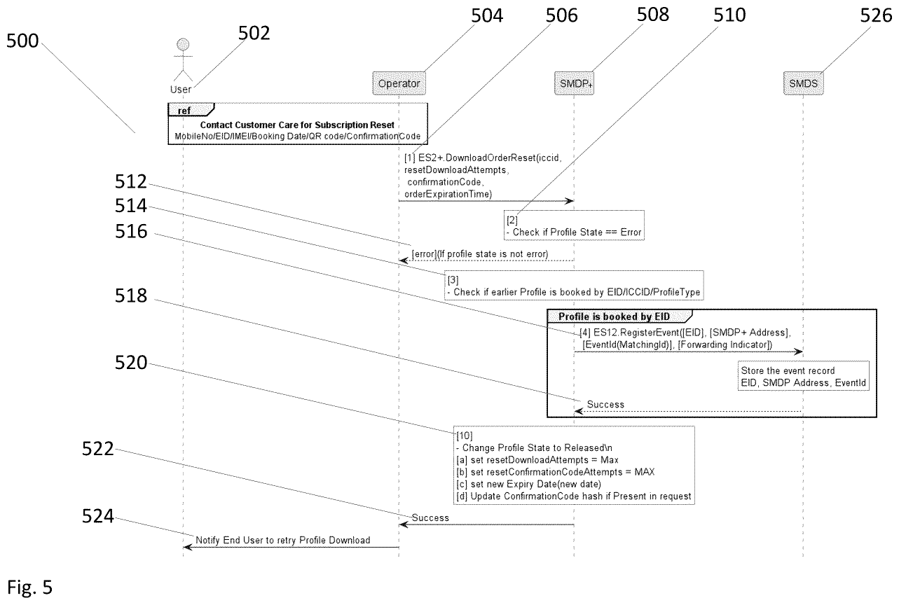

FIG. 5 is a diagram 500 of a pipeline of the function of each entity related to checking a state of a SIM profile, in accordance with some embodiments.

End User 502 refers to a subscriber of Operator 504/370. In some embodiments, the End User 502 is able to contact the Operator 504/370 so the Operator 504/370 is able to communicate with the SM-DP+ 508/310, and the SM-DP+ 508/310 is able to convert the profile from the Error state 510/416 back to the Released state 410 via the ES2+.DownloadOrderReset function request 506. The SM-DP+ 508/310 first determines whether the profile is in the Error state 510/416. If the profile state is not in an error state 512, then the profile is transferred back to the Operator 504/370. If the profile state is in the Error state 510/416, then the SM-DP+ 508/310 determines if the profile is booked 514 by EID. In some embodiments, the SM-DP+ 508/310 determines if the profile is booked 514 by EID by sending 516 an ES.12RegisterEvent function request via the ES12 342 to the SM-DS 526/340, where an event record is created and stored. An event record is a set of information stored on the SM-DS 526/340 for a specific event, via a event registration procedure. An event is an occurrence of a Profile download set by the SM-DP+ 508/310 on behalf of the Operator 504/370, to be processed by a specific eUICC. An event registration is a procedure notifying the SM-DS 526/340 on the availability of information on either a specific SM-DP+ 508/310 or a specific SM-DS 526/340 for a specific eUICC. In some embodiments, the event record is the Event-ID, which is a unique identifier of an Event for a specific EID generated by the SM-DP+ 508/310/SM-DS 526/340. In some embodiments, the event record is the EID. In some embodiments, the event record is the SM-DP+ address, or the SM-DS address. After the event record is created and stored then the profile is sent back 518 from the SM-DS 526/340 via ES12 342 to the SM-DP+ 508/310. After the profile is sent back to the SM-DP+ 508/310 then the profile is able to be reset 520 to the Released state 410. After the profile is successfully reset 522 to the Released state 410, then the profile is sent back to the Operator 504/370 via ES2+376, and a notification 524 is then sent to the end user 502 informing the end user to retry downloading the profile.

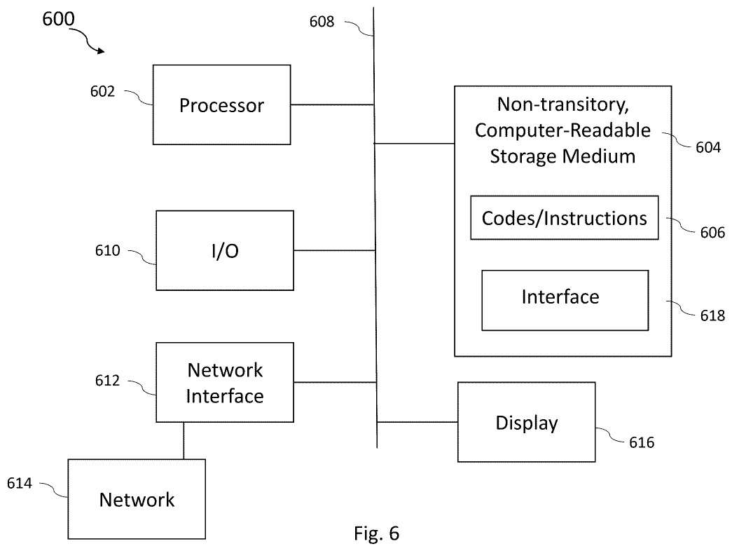

FIG. 6 is a high-level functional block diagram of a processor-based system, in accordance with some embodiments.

In some embodiments, system 600 is a general-purpose computing device including a hardware processing circuitry 602 and a non-transitory, computer-readable storage medium 604. Storage medium 604, amongst other things, is encoded with, i.e., stores, computer instructions 606, i.e., a set of executable instructions such as a AI recommended auto-assurance policy manager. Execution of instructions 606 by hardware processing circuitry 602 represents (at least in part) a tool which implements a portion or all the methods, such as methods 300, 400, and 500, described herein in accordance with one or more embodiments (hereinafter, the noted processes and/or methods).

Hardware processing circuitry 602 is electrically coupled to a computer-readable storage medium 604 via a bus 608. Hardware processing circuitry 602 is further electrically coupled to an I/O interface 610 by bus 608. A network interface 612 is further electrically connected to processing circuitry 602 via bus 608. Network interface 612 is connected to a network 614, so that processing circuitry 602 and computer-readable storage medium 604 connect to external elements via network 614. Processing circuitry 602 is configured to execute computer instructions 606 encoded in computer-readable storage medium 604 in order to cause system 600 to be usable for performing the noted processes and/or methods, such as methods 300, 400, and 500, of FIGS. 3, 4, and 5. In one or more embodiments, processing circuitry 602 is a central processing unit (CPU), a multi-processor, a distributed processing system, an application specific integrated circuit (ASIC), and/or a suitable processing unit.

In one or more embodiments, computer-readable storage medium 604 is an electronic, magnetic, optical, electromagnetic, infrared, and/or a semiconductor system (or apparatus or device). For example, computer-readable storage medium 604 includes a semiconductor or solid-state memory, a magnetic tape, a removable computer diskette, a random-access memory (RAM), a read-memory (ROM), a rigid magnetic disk, and/or an optical disk. In one or more embodiments using optical disks, computer-readable storage medium 604 includes a compact disk-read memory (CD-ROM), a compact disk-read/write (CD-R/W), and/or a digital video disc (DVD).

In one or more embodiments, storage medium 604 stores computer instructions 606 configured to cause system 600 to be usable for performing a portion or the noted processes and/or methods. In one or more embodiments, storage medium 604 further stores information, such as a AI recommended auto-assurance policy engine which facilitates performing the noted processes and/or methods.

System 600 includes I/O interface 610 that is like UI 208. I/O interface 610 is coupled to external circuitry. In one or more embodiments, I/O interface 610 includes a keyboard, keypad, mouse, trackball, trackpad, touchscreen, cursor direction keys and/or other suitable I/O interfaces are within the contemplated scope of the disclosure for communicating information and commands to processing circuitry 602.

System 600 further includes network interface 612 coupled to processing circuitry 602. Network interface 612 allows system 600 to communicate with network 614, to which one or more other computer systems are connected. Network interface 612 includes wireless network interfaces such as BLUETOOTH, WIFI, WIMAX, GPRS, or WCDMA; or wired network interfaces such as ETHERNET, USB, or IEEE-864. In one or more embodiments, noted processes and/or methods, are implemented in two or more system 600.

System 600 is configured to receive information through I/O interface 610. The information received through I/O interface 610 includes one or more of instructions, data, and/or other parameters for processing by processing circuitry 602. The information is transferred to processing circuitry 602 via bus 608. System 600 is configured to receive information related to a UI, such as UI 618, through I/O interface 610. The information is stored in computer-readable medium 604 as user interface (UI) 208.

In some embodiments, the noted processes and/or methods are implemented as a standalone software application for execution by processing circuitry. In some embodiments, the noted processes and/or methods are implemented as a software application that is a part of an additional software application. In some embodiments, the noted processes and/or methods is implemented as a plug-in to a software application.

In some embodiments, the processes are realized as functions of a program stored in a non-transitory computer readable recording medium. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

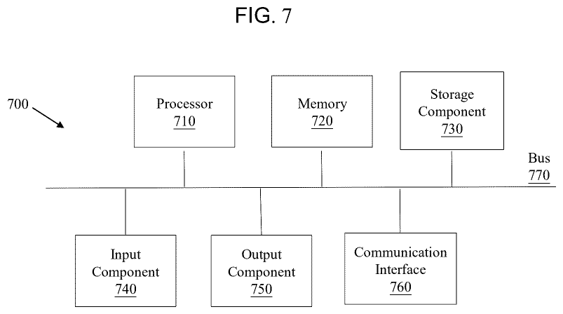

FIG. 7 illustrates an exemplary embodiment of a device 700. As shown in FIG. 7, the device 700 may include a processor 710, a memory 720, a storage component 730, an input component 740, an output component 750, a communication interface 760, and a bus 770.

The processor 710, as used herein, means any type of computational circuit that may comprise hardware elements and software elements. The processor 710 may be embodied as a multi-core processor, a single core processor, or a combination of one or more multi-core processors and one or more single core processors, a distributed processing system, or the like. The processor 710 may be a Central Processing Unit (CPU) a graphics processing unit (GPU), an accelerated processing unit (APU), an application-specific integrated circuit (ASIC), or another type of processing component.

Memory 720 includes a random-access memory (RAM), a read only memory (ROM), and/or another type of dynamic or static storage device (e.g., a flash memory, a magnetic memory, and/or an optical memory) that stores information and/or instructions for use by processor 710. The memory 720 comprises machine-readable instructions which are executable by the processor 710. These machine-readable instructions when executed by the processor 710 causes the processor 710 to perform method steps of an exemplary embodiment described herein.

Storage component 730 stores information and/or software related to the operation and use of the device 700. For example, storage component 730 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 740 is configured to receive information, such as via user input. For example, the input component 740 may include, but not be limited to, a touch screen display, a keyboard, a keypad, a mouse, a button, a switch, and/or a microphone. Additionally, or alternatively, the input component 740 may include a sensor for sensing information (e.g., a global positioning system (GPS), an accelerometer, a gyroscope, and/or an actuator).

Output component 750 is configured to provide output information from the device 700. For example, the output component 750 may be, but not limited to, a display, a speaker, and/or one or more light-emitting diodes (LEDs).

Communication interface 760 is an interface that provides a communication connection to other devices. The connection by the communication interface 760 can be a wired connection, a wireless connection, or a combination of wired and wireless connections, and can be a direct connection or an indirect connection via a communication network that exists between other devices. In other words, the standard of the communication interface 760 is not limited.

The bus 770 acts as an interconnect between the processor 710, the memory 720, the storage component 730, the input component 740, the output component 750, and the communication interface 760 of the device 700.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

### Supplemental Note 1

A method of provisioning a device profile includes receiving, by a Subscription Management Data Preparation (SM-DP+) server, a request to download a profile package to an embedded Universal Integrated Circuit Card (eUICC) of a user equipment (UE). The method includes sending, by the SM-DP+ server, the profile package to the eUICC. The method includes determining, by the SM-DP+ server, whether the profile package is in an error state. The method includes resetting, by the SM-DP+, the profile package to be in a released state to download in response to the SM-DP+ determining the error state. The method includes sending a notification to an end user informing the end user the profile package is available to download.

### Supplemental Note 2

In some embodiments, the method of Supplemental Note 1, including resetting of the profile package comprises sending, by an operator interface, a DownloadOrderReset function request to the SM-DP+

### Supplemental Note 3

In some embodiments, the method of Supplemental Notes 1 and 2, including the DownloadOrderReset function request including a resetDownloadAttempts parameter, a confirmationCode parameter, and an orderExpirationTime parameter.

### Supplemental Note 4

In some embodiments, the method of Supplemental Notes 1-3, including the error state of the profile package includes an error occurring due to: exceeding a confirmation code retry limit, exceeding a download retry limit, failing an eligibility check, or expiring order date.

### Supplemental Note 5

In some embodiments, the method of Supplemental Notes 1-4, including the SM-DP+ determining the profile package is in the error state the SM-DP+ is configured to send a request to a Subscription Management Discovery (SM-DS) server, the SM-DS, in response to receiving the request, determining the profile package is booked by an eUICC Identifier (EID) of the eUICC.

### Supplemental Note 6

In some embodiments, the method of Supplemental Notes 1-5, including in the determining the profile package is booked by an eUICC Identifier (EID) of the eUICC the SM-DS registers an event, and the event is an occurrence of the profile package being downloaded.

### Supplemental Note 7

In some embodiments, the method of Supplemental Notes 1-6, including the resetting of the profile package including setting: the confirmation code retry limit to a maximum amount, the download retry limit to a maximum amount, or the expiring order date to a new date.

### Supplemental Note 8

A Subscription Management Data Preparation (SM-DP+) server for provisioning a profile, the SM-DP+ server is configured to execute the computer-readable instructions to receive a request to download a profile package to an embedded Universal Integrated Circuit Card (eUICC) of a user equipment (UE), send the profile package to the eUICC, determine whether the profile package is in an error state, reset the profile package to be in a released state to download in response to the SM-DP+ determining the error state, and send a notification to an end user informing the end user the profile package is available to download.

### Supplemental Note 9

In some embodiments, the device of Supplemental Note 8, the the SM-DP+ server resets the profile package by sending, from an operator interface, a DownloadOrderReset function request to the SM-DP+.

### Supplemental Note 10

In some embodiments, the device of Supplemental Notes 8 and 9, including the DownloadOrderReset function request including a resetDownloadAttempts parameter, a confirmationCode parameter, and an orderExpirationTime parameter.

### Supplemental Note 11

In some embodiments, the device of Supplemental Notes 8-10, including the error state of the profile package including an error occurring due to: exceeding a confirmation code retry limit, exceeding a download retry limit, failing an eligibility check, or expiring order date.

### Supplemental Note 12

In some embodiments, the device of Supplemental Notes 8-11, including the the SM-DP+ server is further configured to, in response to determining the profile package is in the error state, send a request to a Subscription Management Discovery (SM-DS) server, and the SM-DS, in response to receiving the request, determines the profile package is booked by an eUICC Identifier (EID) of the eUICC.

### Supplemental Note 13

In some embodiments, the device of Supplemental Notes 8-12, including the the SM-DP+ server is further configured to determine the profile package is booked by an eUICC Identifier (EID) of the eUICC, and the SM-DS registers an event, and the event is an occurrence of the profile package being downloaded.

### Supplemental Note 14

In some embodiments, the device of Supplemental Notes 8-13, wherein the resetting of the profile package including setting: the confirmation code retry limit to a maximum amount, the download retry limit to a maximum amount, or the expiring order date to a new date.

### Supplemental Note 15

A non-transitory computer-readable media having computer-readable instructions stored thereon, which in response to being executed causes a Subscription Management Data Preparation (SM-DP+) server to perform operations including receiving, by the SM-DP+ server, a request to download a profile package to an embedded Universal Integrated Circuit Card (eUICC) of a user equipment (UE), sending, by the SM-DP+ server, the profile package to the eUICC, determining, by the SM-DP+ server, whether the profile package is in an error state, resetting, by the SM-DP+, the profile package to be in a released state to download in response to the SM-DP+ determining the error state, and sending a notification to an end user informing the end user the profile package is available to download.

### Supplemental Note 16

In some embodiments, the SM-DP+ server of Supplemental Notes 15, performs the resetting of the profile package includes sending, by an operator interface, a DownloadOrderReset function request to the SM-DP+.

### Supplemental Note 17

In some embodiments, according to the Supplemental Notes 15 and 16, the DownloadOrderReset function request comprises a resetDownloadAttempts parameter, a confirmationCode parameter, and an orderExpirationTime parameter.

### Supplemental Note 18

In some embodiments, according to the Supplemental Notes 15-17, the error state of the profile package includes an error occurring due to: exceeding a confirmation code retry limit, exceeding a download retry limit, failing an eligibility check, or expiring order date.

### Supplemental Note 19

In some embodiments, according to the Supplemental Notes 15-18, wherein, in response to the SM-DP+ determining the profile package is in the error state the SM-DP+ is configured to send a request to a Subscription Management Discovery (SM-DS) server, the SM-DS, in response to receiving the request, determining the profile package is booked by an eUICC Identifier (EID) of the eUICC.

### Supplemental Note 20

In some embodiments, according to the Supplemental Notes 15-19, wherein in the determining the profile package is booked by an eUICC Identifier (EID) of the eUICC the SM-DS registers an event, and the event is an occurrence of the profile package being downloaded.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method of provisioning a device profile, comprising:
receiving, by a Subscription Management Data Preparation (SM-DP+) server, a request to download a profile package to an embedded Universal Integrated Circuit Card (eUICC) of a user equipment (UE);
sending, by the SM-DP+ server, the profile package to the eUICC;
determining, by the SM-DP+ server, whether the profile package is in an error state;
resetting, by the SM-DP+, the profile package to be in a released state to download in response to the SM-DP+ determining the error state; and
sending a notification to an end user informing the end user the profile package is available to download.

2. The method of claim 1, wherein the resetting of the profile package comprises sending, by an operator interface, a DownloadOrderReset function request to the SM-DP+.

3. The method of claim 2, wherein the DownloadOrderReset function request comprises a resetDownloadAttempts parameter, a confirmationCode parameter, and an orderExpirationTime parameter.

4. The method of claim 1, wherein the error state of the profile package comprises an error occurring due to: exceeding a confirmation code retry limit, exceeding a download retry limit, failing an eligibility check, or expiring order date.

5. The method of claim 1, wherein, in response to the SM-DP+ determining the profile package is in the error state the SM-DP+ is configured to send a request to a Subscription Management Discovery (SM-DS) server, the SM-DS, in response to receiving the request, determining the profile package is booked by an eUICC Identifier (EID) of the eUICC.

6. The method of claim 5, wherein in the determining the profile package is booked by an eUICC Identifier (EID) of the eUICC the SM-DS registers an event, and the event is an occurrence of the profile package being downloaded.

7. The method of claim 4, wherein the resetting of the profile package comprises setting: the confirmation code retry limit to a maximum amount, the download retry limit to a maximum amount, or the expiring order date to a new date.

8. A Subscription Management Data Preparation (SM-DP+) server for provisioning a profile configured to:
receive a request to download a profile package to an embedded Universal Integrated Circuit Card (eUICC) of a user equipment (UE);
send the profile package to the eUICC;
determine whether the profile package is in an error state;
reset the profile package to be in a released state to download in response to the SM-DP+ determining the error state; and
send a notification to an end user informing the end user the profile package is available to download.

9. The SM-DP+ server of claim 8, wherein the SM-DP+ server is further configured to reset the profile package by sending, from an operator interface, a DownloadOrderReset function request to the SM-DP+.

10. The SM-DP+ server of claim 9, wherein the DownloadOrderReset function request comprises a resetDownloadAttempts parameter, a confirmationCode parameter, and an orderExpirationTime parameter.

11. The SM-DP+ server of claim 8, wherein the error state of the profile package comprises an error occurring due to: exceeding a confirmation code retry limit, exceeding a download retry limit, failing an eligibility check, or expiring order date.

12. The SM-DP+ server of claim 8, wherein the SM-DP+ server is further configured to, in response to determining the profile package is in the error state, send a request to a Subscription Management Discovery (SM-DS) server, and the SM-DS, in response to receiving the request, determines the profile package is booked by an eUICC Identifier (EID) of the eUICC.

13. The SM-DP+ server of claim 12, wherein the SM-DP+ server is further configured to determine the profile package is booked by an eUICC Identifier (EID) of the eUICC, and the SM-DS registers an event, and the event is an occurrence of the profile package being downloaded.

14. The SM-DP+ server of claim 11, wherein the resetting of the profile package comprises setting: the confirmation code retry limit to a maximum amount, the download retry limit to a maximum amount, or the expiring order date to a new date.

15. A non-transitory computer-readable media having computer-readable instructions stored thereon, which in response to being executed causes a Subscription Management Data Preparation (SM-DP+) server to perform operations comprising:
receiving, by the SM-DP+ server, a request to download a profile package to an embedded Universal Integrated Circuit Card (eUICC) of a user equipment (UE);
sending, by the SM-DP+ server, the profile package to the eUICC;
determining, by the SM-DP+ server, whether the profile package is in an error state;
resetting, by the SM-DP+, the profile package to be in a released state to download in response to the SM-DP+ determining the error state; and
sending a notification to an end user informing the end user the profile package is available to download.

16. The non-transitory computer-readable media of claim 15, wherein the resetting of the profile package comprises sending, by an operator interface, a DownloadOrderReset function request to the SM-DP+.

17. The non-transitory computer-readable media of claim 16, wherein the DownloadOrderReset function request comprises a resetDownloadAttempts parameter, a confirmationCode parameter, and an orderExpirationTime parameter.

18. The non-transitory computer-readable media of claim 15, wherein the error state of the profile package comprises an error occurring due to: exceeding a confirmation code retry limit, exceeding a download retry limit, failing an eligibility check, or expiring order date.

19. The non-transitory computer-readable media of claim 15, wherein, in response to the SM-DP+ determining the profile package is in the error state the SM-DP+ is configured to send a request to a Subscription Management Discovery (SM-DS) server, the SM-DS, in response to receiving the request, determining the profile package is booked by an eUICC Identifier (EID) of the eUICC.

20. The non-transitory computer-readable media of claim 19, wherein in the determining the profile package is booked by an eUICC Identifier (EID) of the eUICC the SM-DS registers an event, and the event is an occurrence of the profile package being downloaded.
